(19) United States
(12) Patent Application Publication
(10) Pub. No.: US 2002/0078025 A1
(43) Pub. Date: Jun. 20, 2002

(54) SYSTEMS AND METHODS FOR INFORMATION SEARCHING

(75) Inventor: Toshio Tanaka, Shiojiri-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 09/984,394

(22) Filed: Oct. 30, 2001

(30) Foreign Application Priority Data
Oct. 31, 2000 (JP) 2000-333933

(51) Int. Cl. G06F 7/00

(52) U.S. Cl. 707/1

(57) ABSTRACT

To provide a content search system which is suitable for obtaining a search result desirable for the user and a required number of matches.

A content distribution terminal 100 searches a content registration DB 42 for content for postings based on assigned search conditions, corrects the search conditions by adding categories and keywords if the number of matches retrieved by the search is smaller than a predetermined lower limit, and performs a search again based on the search conditions which have been corrected. If the number of matches is larger than a predetermined upper limit, the content distribution terminal 100 corrects the search conditions by replacing a category with a lower-level category or deleting keywords, and performs a search again based on the search conditions which have been corrected. Then, the content distribution terminal 100 lays out the content for postings which has been retrieved according to an output layout determined therefor, and distributes the digital content which has been created to the user.

### TECHNICAL FIELD

The present invention relates to a system and a storage medium for searching for content to be posted as digital content when the digital content is created, and more specifically to an information searching system, a content search system, a content distribution system, and a storage medium storing an information searching program, which are suitable for obtaining a search result desirable for the user and a required number of matches.

### BACKGROUND ART

Hitherto, as systems for searching for information, for example, systems which search for information according to a method based on Boolean logic have been available, and typically, search engines on the Internet are widely known.

In recent years, services which distribute digital content such as news by e-mail have become common. In the news distribution service, if the user notifies in advance a distribution server of a category of his interest, the distribution server distributes news in the category specified by the user to a user terminal as digital content.

As such news distribution services come to be utilized in the future, there will be a need that only news which matches the interest or preference of a user be distributed. In addition, due to a desire to read digital content just as one reads newspapers or magazines, there will be a need that a predetermined number of news items or number of news items which can be posted on a predetermined page be picked up from a large amount of news and digital content in which the news which has been picked up is clipped for distribution.

In this case, from a content registration database storing a large amount of digital content such as news, digital content of news which matches the interest or preference of the user must be retrieved by a search by the predetermined number of news items or the number of news items which can be posted on the predetermined page. The search is performed based on a category or a keyword specified by the user. For example, if the user specifies the category of “sports”, digital content which belongs to the category of “sports” is retrieved.

However, according to the conventional information searching system, when a search is performed based on the category or keyword specified by the user, it is difficult to retrieve digital content exactly matching the predetermined number of news items or the number of news items which can be posted on the predetermined page. More specifically, the number of matches will be larger than necessary if there is a large amount of digital content which belongs to the category specified by the user, and conversely, the number of matches will be smaller than necessary if the user specifies a large amount of keywords because digital content including all the keywords will be limited.

Thus, if the number of matches is larger than necessary, it becomes difficult to distribute news which matches the user's interest or preference. More specifically, if the number of matches is larger than necessary, the matches must be reduced to the predetermined number of news items or the number of news items which can be posted on the predetermined page; however, the reduction must be performed based on the criteria of the distribution server, such as the order of the more recent date or the order of presumable popularity, incurring the possibility that news which does not match the user's interest or preference may be selected.

Conversely, if the number of matches is smaller than necessary, the format of digital content will be deteriorated, possibly causing loss of uniformity of format. For example, a situation may occur that digital content distributed yesterday is configured of ten pages whereas digital content distributed today is configured of only six pages due to the number of matches being smaller than necessary.

Accordingly, the present invention has been made in view of the unsolved problems pertinent to the conventional art described above, and an object thereof is to provide an information searching system, a content search system, a content distribution system, and a storage medium storing an information searching program, which are suitable for obtaining a search result desirable for the user and a required number of matches.

### DISCLOSURE OF INVENTION

In order to achieve the objective, an information searching system according to Claim 1 of the present invention is a system for searching for information from the storage means, which performs a search based on assigned search conditions, corrects the search conditions if the number of matches or the amount of data retrieved by the search does not satisfy a predetermined condition, and performs a search again based on the corrected search conditions.

According to the arrangement, when search conditions are assigned, a search is performed based on the assigned search conditions. If the number of matches or the amount of data retrieved as a result of the search does not satisfy the predetermined condition, the search conditions are corrected, and a search is performed again based on the search conditions which have been corrected. On the other hand, if the number of matches retrieved by the search satisfies the predetermined condition, for example, the search is stopped.

The system may be implemented as a single apparatus, or as a network system in which a plurality of terminals are communicatively connected. In the latter case, each of the components may belong to any of the plurality of terminals as long as they are communicatively connected to each other. Hereinafter, the same applies to information searching systems according to Claims 2 and 3, content search systems according to Claims 4 to 6, and a content distribution system according to Claim 14.

Furthermore, an information searching system according to Claim 2 of the present invention is a system for searching for information from the storage means, which predicts a presumable number of matches or amount of data to be retrieved by a search based on assigned search conditions, corrects the search conditions if the result of the prediction does not satisfy a predetermined condition, performs a prediction again based on the corrected search conditions, and performs a search based on the search conditions if the result of the prediction satisfies the predetermined condition.

According to the arrangement, when search conditions are assigned, a presumable number of matches or amount of data to be retrieved by a search based on the assigned conditions is predicted. If the result of the prediction does not satisfy the predetermined condition, the search conditions are corrected, and a prediction is performed again based on the search conditions which have been corrected. On the other hand, if the result of the prediction satisfies the predetermined condition, a search is performed based on the search conditions.

The arrangement for predicting the number of matches or the amount of data to be retrieved may be arbitrary as long as the number of matches or the amount of data is predicted. For example, the number of matches or the amount of data may be predicted directly, or the number of matches or the amount of data may be predicted indirectly. In the latter case, for example, the number of matches or the amount of data may be predicted indirectly by detecting the number of assigned categories or keywords when categories or keywords are assigned as search conditions. Hereinafter, the same applies to an information searching system according to Claim 3, and storage media storing information search programs according to Claims 16 and 17.

Furthermore, an information searching system according to Claim 3 of the present invention is a system for searching for information from the storage means, which predicts a presumable number of matches or amount of data to be retrieved by a search based on assigned search conditions, corrects the search conditions if the result of the prediction does not satisfy a first predetermined condition, performs a search based on the corrected search conditions, corrects the search conditions if the number of matches retrieved by the search does not satisfy a second predetermined condition, and performs a prediction and a search again.

According to the arrangement, when search conditions are assigned, a presumable number of matches or amount of data to be retrieved by a search based on the search conditions is predicted. If the result of the prediction does not satisfy the first predetermined condition, the search conditions are corrected, and a search is performed based on the search conditions which have been corrected. If the number of matches retrieved as a result of the search does not satisfy the second predetermined conditions, the search conditions are corrected, and a prediction and a search are performed again.

On the other hand, if the result of the prediction satisfies the first predetermined condition, for example, a search is performed based on the search conditions. If the number of matches retrieved by the search satisfies the second predetermined condition, for example, the search is stopped.

Furthermore, in order to achieve the objective, a content search system according to Claim 4 of the present invention is a system for searching a content storage means for content for postings, stored therein, of a predetermined number of items or a number of items which can be posted in a predetermined posting area when creating digital content on which the content for postings is posted, the content search system comprising a content searching means for searching said content storage means for the content for postings based on assigned search conditions, and a search condition correcting means for correcting the search conditions if the number of matches retrieved by said content searching means does not satisfy a predetermined condition, wherein said content searching means performs a search again based on the search conditions which have been corrected by said search condition correcting means.

According to the arrangement, when search conditions are assigned, the content searching means searches the content storage means for content for postings based on the assigned search conditions. If the number of matches retrieved as a result of the search does not satisfy the predetermined condition, the search conditions correcting means corrects the search conditions, and the content searching means performs a search again based on the search conditions which have been corrected. On the other hand, if the number of matches retrieved by the search satisfies the predetermined condition, for example, the search is stopped.

Furthermore, a content search system according to Claim 5 of the present invention is a system for searching a content storage means for content for postings, stored therein, of a predetermined number of items or a number of items which can be posted in a predetermined posting area when creating digital content on which the content for postings is posted, the content search system comprising a prediction means for predicting a presumable number of matches to be retrieved by a search based on assigned search conditions, a search condition correcting means for correcting the search conditions if the result of the prediction by said prediction means does not satisfy a predetermined condition, and a content searching means for searching said content storage means for the content for postings based on the search conditions satisfying the predetermined condition, wherein said prediction means performs a prediction again based on the search conditions which have been corrected by said search condition correcting.

According to the arrangement, when search conditions are assigned, the prediction means predicts a presumable number of matches to be retrieved by a search based on the assigned conditions. If the result of the prediction does not satisfy the predetermined condition, the search condition correcting means corrects the search conditions, and the prediction means performs a prediction again based on the search conditions which have been corrected. On the other hand, if the result of the prediction satisfies the predetermined condition, the content searching means searches the content storage means for content for postings based on the search conditions.

The arrangement of the prediction means may be arbitrary as long as a presumable number of matches to be retrieved is predicted. For example, the number of matches may be predicted directly, or the number of matches may be predicted indirectly. In the latter case, for example, the number of matches may be predicted indirectly by detecting the number of assigned categories or keywords when categories or keywords are assigned as search conditions. Hereinafter, the same applies to a content search system according to Claim 6.

Furthermore, a content search system according to Claim 6 of the present invention is a system for searching a content storage means for content for postings, stored therein, of a predetermined number of items or a number of items which can be posted in a predetermined posting area when creating digital content on which the content for postings is posted, the content search system comprising a predicting means for predicting a presumable number of matches to be retrieved by a search based on assigned search conditions, a search condition correcting means for correcting the search conditions, and a content searching means for searching said content storage means for the content for postings based on the search conditions, wherein if the result of the prediction by said prediction means does not satisfy a first predetermined condition, said search condition correcting means performs a correction, and if the number of matches retrieved by said content searching means does not satisfy a second predetermined condition, said search condition correcting means performs a correction, said prediction means performs a prediction again, and said content searching means performs a search again.

According to the arrangement, when search conditions are assigned, the prediction means predicts a presumable number of matches to be retrieved by a search based on the search conditions. If the result of the prediction does not satisfy the first predetermined condition, the search condition correcting means corrects the search conditions, and the content storage means is searched for content for postings based on the search conditions which have been corrected. If the number of matches retrieved as a result of the search does not satisfy the second predetermined conditions, the search condition correcting means corrects the search conditions, the prediction means performs a prediction again, and the content searching means performs a search again.

On the other hand, if the result of the prediction satisfies the first predetermined condition, for example, the content searching means performs a search based on the search conditions. If the number of matches retrieved by the search satisfies the second predetermined condition, for example, the search is stopped.

Furthermore, a content search system according to Claim 7 of the present invention is a content search system according to one of Claims 4 to 6, wherein the search conditions include a category of the content for postings, and said search condition correcting means narrows the range of the category in the search conditions if the number of matches is larger than a predetermined upper limit and expands the range of the category in the search conditions if the number of matches is smaller than a predetermined lower limit.

According to the arrangement, the search condition correcting means narrows the range of category in the search conditions if the number of matches is larger than the predetermined upper limit. On the other hand, the search condition correcting means expands the range of the category in the search conditions if the number of matches is smaller than the predetermined lower limit.

Furthermore, a content search system according to Claim 8 of the present invention is a content search system according to one of Claims 4 to 7, wherein the search conditions include a search expression consisting of a combination of a plurality of search keys and a predetermined conditional expression or a single search key, said content searching means performs a search according to the search expression, and said search condition correcting means alters the search expression in the search conditions so as to narrow the search range by said content searching means if the number of matches is larger than a predetermined upper limit and alters the search expression in the search conditions so as to expand the search range by said content searching means if the number of matches is smaller than a predetermined lower limit.

According to the arrangement, the search condition correcting means alters the search expression in the search conditions so as to narrow the range of search by the content searching means if the number of matches is larger than the predetermined upper limit. On the other hand, the search condition correcting means alters the search expression in the search conditions so as to expand the range of search by the content searching means if the number of matches is smaller than the predetermined lower limit.

Furthermore, a content search system according to Claim 9 of the present invention is a content search system according to Claim 8, wherein said search condition correcting means increases the number of search keys included in the search expression in the search conditions if the number of matches is larger than the predetermined upper limit and decreases the number of search keys included in the search expression in the search conditions if the number of matches is smaller than the predetermined lower limit.

According to the arrangement, the search condition correcting means increases the number of search keys included in the search expression in the search conditions if the number of matches is larger than the predetermined upper limit. On the other hand, the search condition correcting means decreases the number of search keys included in the search expression in the search conditions if the number of matches is smaller than the predetermined lower limit.

Furthermore, a content search system according to Claim 10 of the present invention is a content search system according to one of Claims 5 and 6, wherein the search conditions include a category of the content for postings, and said search condition correcting means narrows the range of the category in the search conditions if the number of matches is determined to be presumably larger than a predetermined upper limit based on the result of the prediction and expands the range of the category in the search conditions if the number of matches is determined to be presumably smaller than a predetermined lower limit based on the result of the prediction.

According to the arrangement, the search condition correcting means narrows the range of category in the search conditions if the number of matches is determined to be presumably larger than the predetermined upper limit based on the result of the prediction. On the other hand, the search condition correcting means expands the range of the category in the search conditions if the number of matches is determined to be presumably smaller than the predetermined lower limit based on the result of the prediction.

Furthermore, a content search system according to Claim 11 of the present invention is a content search system according to one of Claims 5, 6, and 10, wherein the search conditions include a search expression consisting of a combination of a plurality of search keys and a predetermined conditional expression or a single search key, said content searching means performs a search according to the search expression, and said search condition correcting means alters the search expression in the search conditions so as to narrow the search range by said content searching means if the number of matches is determined to be presumably larger than a predetermined upper limit based on the result of the prediction and alters the search expression in the search conditions so as to expand the search range by said content searching means if the number of matches is determined to be presumably smaller than a predetermined lower limit based on the result of the prediction.

According to the arrangement, the search condition correcting means alters the search expression in the search conditions so as to narrow the range of search by the content searching means if the number of matches is determined to be presumably larger than the predetermined upper limit. On the other hand, the search condition correcting means alters the search expression in the search conditions so as to expand the range of search by the content searching means if the number of matches is determined to be presumably smaller than the predetermined lower limit.

Furthermore, a content search system according to Claim 12 of the present invention is a content search system according to Claim 11, wherein said search condition correcting means increases the number of search keys included in the search expression in the search conditions if the number of matches is determined to be presumably larger than the predetermined upper limit based on the result of the prediction and decreases the number of search keys included in the search expression in the search conditions if the number of matches is determined to be presumably smaller than the predetermined lower limit based on the result of the prediction.

According to the arrangement, the search condition correcting means increases the number of search keys included in the search expression of the search conditions if the number of matches is determined to be presumably larger than the predetermined upper limit. On the other hand, the number of search keys included in the search expression in the search conditions is decreased if the number of matches is determined to be presumably smaller than the predetermined lower limit.

Furthermore, a content search system according to Claim 13 of the present invention is a content search system according to one of Claims 9 and 12, wherein said search condition correcting means adds a search keys related to a search key included in the search expression in the search conditions when increasing the number of search keys.

According to the arrangement, the search condition correcting means adds a search key related to a search key included in the search expression in the search conditions when increasing the number of search keys.

Furthermore, in order to achieve the objective, a content distribution system according to Claim 14 of the present invention is a system for distributing digital content on which content for postings of a predetermined number of items or a number of items which can be posted in a predetermined posting area is posted to a user, the content distribution system comprising a user information storage means for storing user information including search conditions specified by the user, a content storage means for storing the content for postings, a content selecting means for selecting the content for postings from said content storage means based on the search conditions in said user information storage means, a digital content creating means for creating the digital content using the content for postings selected by said content selecting means, and a content distribution means for distributing the digital content created by said content creating means to the user, wherein a content search system according to one of Claims 4 to 13 is applied to said content selecting means.

According to the arrangement, the content selecting means selects content for postings from the content storage means based on the search conditions in the user information storage means, the content creating means creates digital content using the content for postings which has been selected, and the content distribution means distributes the digital content which has been created to the user. The selection by the content selecting means provides operation equivalent to that of a content search system according to one of Claims 6 to 13.

Furthermore, in order to achieve the objective, a storage medium storing an information searching program according to Claim 15 of the present invention is a computer-readable storage medium storing an information searching program for searching for information from the storage means, the storage means storing a program for executing on a computer a process for performing a search based on assigned search conditions, correcting the search conditions if the number of matches retrieved by the search does not satisfy a predetermined condition, and performing a search again based on the corrected search conditions.

According to the arrangement, when the information searching program stored in the storage medium is read by a computer and the computer executes the program which has been read, operation and advantages equivalent to those of an information searching system according to Claim 1.

Furthermore, a storage medium storing an information searching program according to Claim 16 of the present invention is a computer-readable storage medium storing an information searching program for searching for information from the storage means, the storage means storing a program for executing on a computer a process for predicting a presumable number of matches to be retrieved by a search based on assigned search conditions, correcting the search conditions if the result of the prediction does not satisfy a predetermined condition, performing a prediction again based on the corrected search conditions, and performing a search based on the search conditions if the result of the prediction satisfies the predetermined condition.

According to the arrangement, when the information searching program stored in the storage medium is read by a computer and the computer executes the program which has been read, operation and advantages equivalent to those of an information searching system according to Claim 2.

Furthermore, a storage medium storing an information searching program according to Claim 17 of the present invention is a computer-readable storage medium storing an information searching program for searching for information from the storage means, the storage means storing a program for executing on a computer a process for predicting a presumable number of matches to be retrieved by a search based on assigned search conditions, correcting the search conditions if the result of the prediction does not satisfy a first predetermined condition, performing a search based on the corrected search conditions, correcting the search conditions if the number of matches retrieved by the search does not satisfy a second predetermined condition, and performing a prediction and a search again.

According to the arrangement, when the information searching program stored in the storage medium is read by a computer and the computer executes the program which has been read, operation and advantages equivalent to those of an information searching system according to Claim 3.

### BRIEF DESCRIPTION OF THE DRAWINGS

FIG. 1 is a block diagram showing the configuration of a network system to which the present invention is applied.

FIG. 2 is a block diagram showing the construction of a content distribution terminal 100.

FIG. 3 is a diagram showing the data structure of a user profile table 300.

FIG. 4 is a diagram showing the data structures of a layout definition file and a layout No. association table 330.

FIG. 5 is a diagram showing the data structures of content for postings and a category No. association table 340.

FIG. 6 is a diagram showing a hierarchical classification of categories.

FIG. 7 is a flowchart showing a user registration process.

FIG. 8 is a flowchart showing a content distribution process.

FIG. 9 is a flowchart showing a content searching process.

FIG. 10 is an illustration showing a user ID, etc. input screen.

FIG. 11 is an illustration showing a category specification screen.

FIG. 12 is an illustration showing a destination address, etc. input screen.

FIG. 13 is an illustration showing an output layout, etc. specification screen.

FIG. 14 is an illustration of a registration content confirmation screen.

FIG. 15 is a flowchart showing a content searching process.

FIG. 16 is a flowchart showing a content searching process.

### BEST EMBODIMENT THE INVENTION

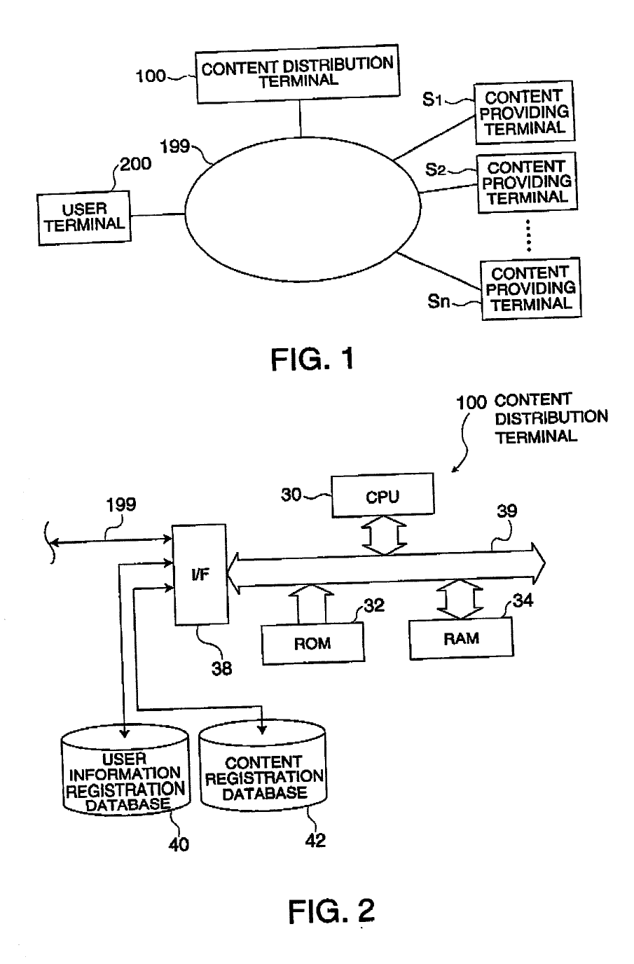

A first embodiment of the present invention will now be described with reference to the drawings. FIGS. 1 to 14 are drawings showing the first embodiment of an information searching system, a content search system, a content distribution system, and a storage medium according to the present invention.

The embodiment applies an information searching system, a content search system, a content distribution system, and a storage medium according to the present invention to a case where a content distribution terminal 100 distributes digital content such as news to a user terminal 200, as shown in FIG. 1, and is particularly characterized by its process of searching for content to be posted. Hereinafter, digital content to be distributed to the user will be referred to simply as “digital content”, and individual digital content to be posted as the digital content will be referred to as “content for postings” in order to make a distinction therebetween.

First, the configuration of a network system to which the present invention is applied will be described with reference to FIG. 1. FIG. 1 is a block diagram showing the configuration of the network system to which the present invention is applied.

As shown in FIG. 1, a plurality of content providing terminals S₁ to Sₙ for providing digital content, a content distribution terminal 100 for collecting, storing, and distributing the digital content provided by the content providing terminals S₁ to Sₙ, and a user terminal 200 to be used by the user are connected to the Internet 199. Although only a single user terminal 200 is shown in order to facilitate understanding of the invention, a plurality of user terminals are actually connected to the Internet 199.

The content providing terminals S₁ to Sₙ are constructed so as to have the same functionality as an ordinary computer in which a CPU, a ROM, a RAM, an I/F, etc. are connected via a bus. When digital content is created, the content providing terminals S₁ to Sₙ add to the digital content a category No. for identifying the category of the digital content, and transmit it to the content distribution terminal 100. Category No. will be described later in more detail.

The user terminal 200 is constructed so as to have the same functionality as an ordinary personal computer in which a CPU, ROM, a RAM, an I/F, etc. are connected via a bus. The user terminal 200 has a WWW browser, and it accesses the content distribution terminal 100 using the WWW browser.

Next, the construction of the content distribution terminal 100 will be described in detail with reference to FIG. 2. FIG. 2 is a block diagram showing the construction of the content distribution terminal 100.

As shown in FIG. 2, the content distribution terminal 100 includes a CPU 30 which controls operations and the overall system according to a control program; a ROM 32 in a predetermined area of which the control program for the CPU, etc. are stored in advance; a RAM 34 for storing data read from the ROM 32, etc. and operation results required in the course of operations by the CPU 30; and an I/F which intermediates data input from and output to external apparatuses; and these are connected to each other so as to allow exchange of data via a bus 39 which serves as a signal line for transferring data.

To the I/F 38, as the external apparatuses, a user information registration database (Hereinafter, database will be abbreviated simply as DB.) 40 for registering user information;, a content registration DB 42 for collecting and storing the digital content provided by the content providing terminals S₁ to Sₙ as content for postings; and a signal line for connection to the Internet 199 are connected.

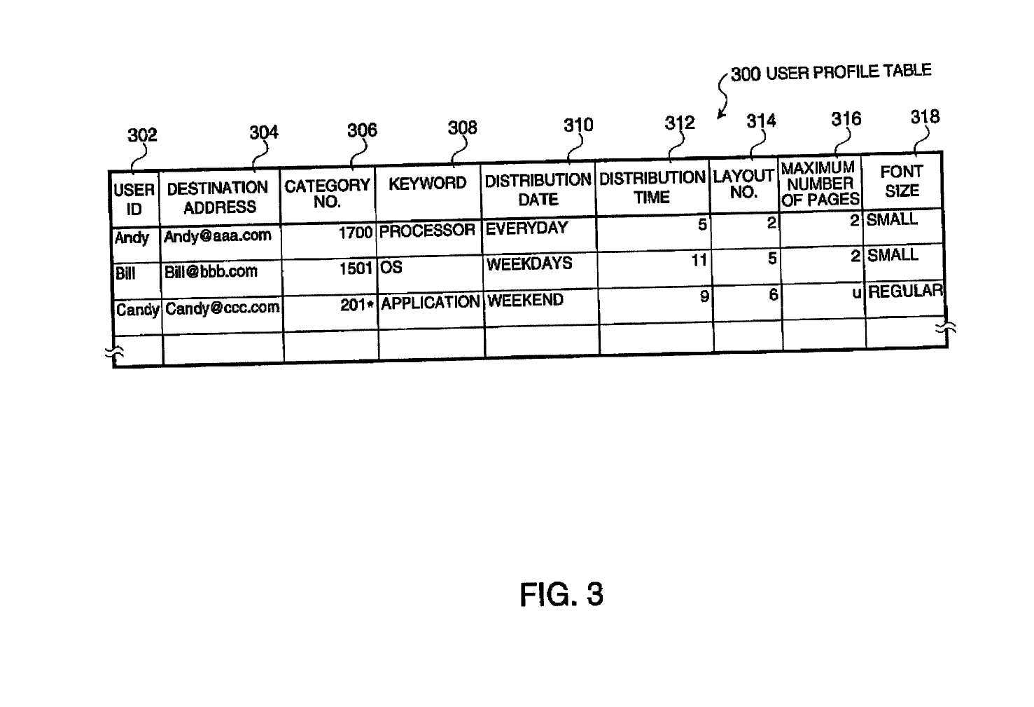

As shown in FIG. 3, the user information registration database 40 stores a user profile table 300 for registering user information. FIG. 3 is a diagram showing the data structure of the user profile table 300.

As shown in FIG. 3, the user profile table 300 allows registration of a single record or a plurality of records for each user. Each record includes a field 302 for registering a user ID for identifying a user, a field 304 for registering a destination address of digital content, a field 306 for registering a category No., a field 308 for registering a keyword, a field 310 for registering a distribution date, a field 312 for registering a distribution time, a field 314 for registering a layout No., a field 316 for registering a maximum number of pages, and a field 318 for registering a font size.

In the field 308, when content for postings including a keyword specified by the user is to be selected for distribution, the keyword is registered. The keyword is, for example, one which presumably appears frequently in articles of a category of the user's interest. In the example shown in FIG. 3, “processor” and “OS” are registered respectively in the first row of the field 308 and the second row of the field 308.

In the field 310, a distribution date on which the user desires digital content to be distributed is registered. The distribution date is specified as, for example, “every day” if the digital content is desired to be distributed every day, “weekdays” if desired to be distributed only on weekdays, and “weekend” if desired to be distributed only on weekend. In the example shown in FIG. 3, “every day” and “weekdays” are registered respectively in the first row of the field 310 and the second row of the field 310.

In the field 312, a distribution time at which the user desires digital content to be distributed on the specified distribution date is registered. The distribution time is specified, for example, as one of 0 o'clock to 23 o'clock in the 24-hour representation. In the example shown in FIG. 3, 5 o'clock and 11 o'clock are registered respectively in the first row of the field 312 and the second row of the field 312.

In the field 314, a layout No. for specifying the output layout of digital content is registered. As the layout No., for example, a layout No. identifying an output layout desired by the user is specified. In the example shown in FIG. 3, layout No. 2 and layout No. 5 are registered respectively in the first row of the field 314 and the second row of the field 314. Layout No. will be described later in more detail.

In the field 316, a maximum number of pages to be allowed in a display or a print of digital content is registered. As the maximum number of pages, for example, a maximum number of pages as an upper limit is specified, or the absence of upper limit may be specified by a designation of “u”. In the example shown in FIG. 3, two pages and “u” are registered respectively in the first row of the field 316 and the third row of the field 316.

In the field 318, a font size to be used in a display or a print of digital content is registered. In the example shown in FIG. 3, “small” and “regular” are registered respectively in the first row of the field 318 and the third row of the field 318.

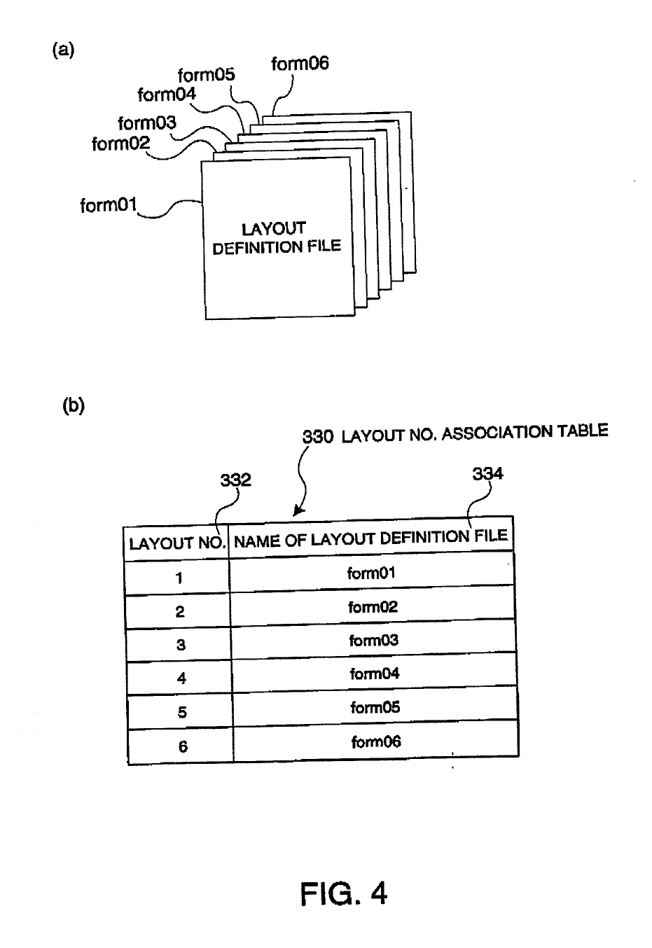

Furthermore, as shown in FIG. 4, the user information registration DB 40 stores a plurality of layout definition files form01 to form06 defining output layouts of digital content, and a layout No. association table 330 showing an association of the layout definition files form01 to form06 with layout Nos. FIG. 4 is a diagram showing the data structures of the layout definition files and the layout No. association table 330.

In the layout No. association table 330, a single record is registered for each layout No., as shown in FIG. 4(b). Each record includes a field 332 in which a layout No. is registered, and a field 334 in which the file name of a layout definition file is registered. In the example shown in FIG. 4(b), “1” and “form01” are registered respectively as the layout No. and the name of layout definition file in the record on the first row, and “2” and “form2” are registered respectively as the layout No. and the name of layout definition file in the record on the second row.

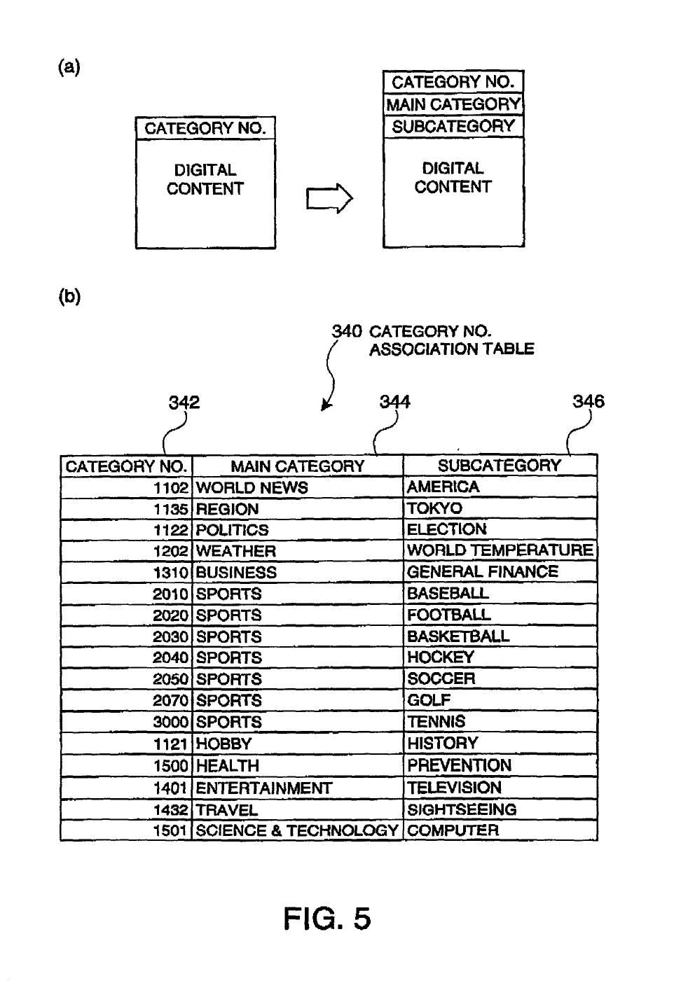

The content registration DB 42 stores content for postings provided by the content providing terminals S₁ to Sₙ, and a category association table 340 showing an association of main categories and subcategories with category Nos. FIG. 5 is a diagram showing the data structures of the content for postings and the category No. association table 340.

As shown in FIG. 5(a), category Nos. are assigned to the digital content provided by the content providing terminals S₁ to Sₙ, so that the content distribution terminal 100 classifies the digital content by category on the basis of the category Nos. and registers in the content registration DB 42 as content for postings. In registration, in addition to the category Nos., main categories and subcategories are assigned to the content for postings with reference to the category No. association table 340.

In the category No. association table 340, a single record is registered for each main category and subcategory, as shown in FIG. 5(b). Each record includes a field 342 in which a category No. is registered, a field 344 in which a main category is registered, and a field 346 in which a subcategory is registered. In the example shown in FIG. 5(b), “1102”, “world news”, and “America” are registered respectively as the category No., the main category, and the subcategory in the record on the first row, and “2010”, “sports”, and “baseball” are registered respectively as the category No., the main category, and the subcategory in the record on the sixth row.

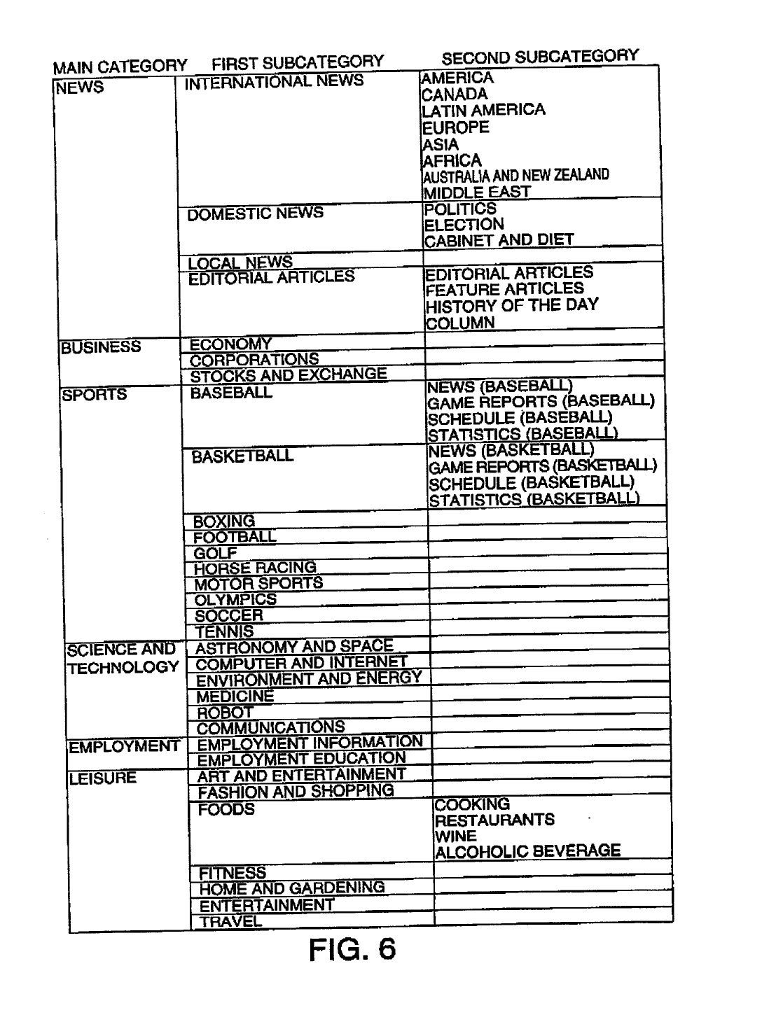

The categories are classified and managed according to the category Nos. as described above, and more specifically, classified hierarchically as shown in FIG. 6. FIG. 6 is a diagram showing the hierarchical classification of the categories.

As shown in FIG. 6, the categories are configured of main categories, primary subcategories which are one level below the main categories, and secondary subcategories which are one level below the first subcategories. In the example shown in FIG. 6, in the main category of “news”, content for postings relating to news in general, and the primary subcategories of “international news”, “domestic news”, “local news”, and “editorial articles” are classified. Furthermore, in the primary subcategory of “domestic news”, content for postings relating to domestic news, and in addition, the secondary subcategories of “politics”, “election”, and “Cabinet and Diet” are classified.

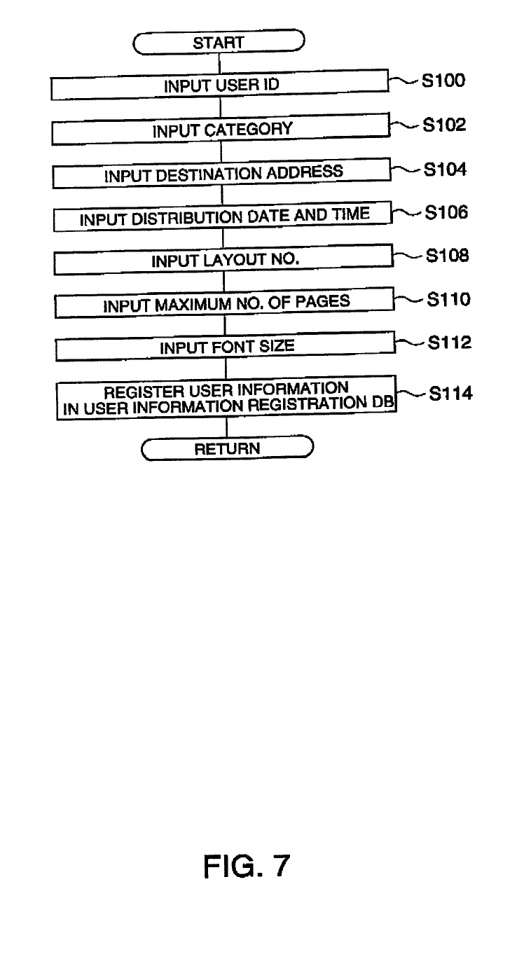

Next, the construction of the CPU 30 and processes to be executed by the CPU 30 will be described with reference to FIGS. 7 to 9.

The CPU 30 is implemented, for example, by a microprocessing unit MPU, and it activates a predetermined program stored in a predetermined area of the ROM 32 and executes each of a user registration process and a content distribution process shown in the flowcharts of FIGS. 7 to 9 by time division according to the program.

First, the user registration process will be described in detail with reference to FIG. 7. FIG. 7 is a flowchart showing the user registration process.

In the user registration process, a user who has accessed is requested to input necessary user information such as a user ID, and the user information which has been input is registered in the user profile table 300. When the user registration process is executed by the CPU 30, the process first enters step S100, as shown in FIG. 7. Input in each subsequent step will all be made by interactive communications with the user.

In step S100, a user ID is input. The process proceeds to step S102, in which a main category and a subcategory are input. The process proceeds to step S104, in which a destination address is input. The process proceeds to step S106, in which a distribution date and a distribution time are input. The process then proceeds to step S108.

In step S108, a layout No. is input. The process proceeds to step S110, in which a maximum number of pages is input. The process proceeds to step S112, in which a font size is input. The process proceeds to step S114, in which the user information which has been input in steps S100 to S112 is registered in the user profile table 300. The series of steps is then exited, returning to the originating process.

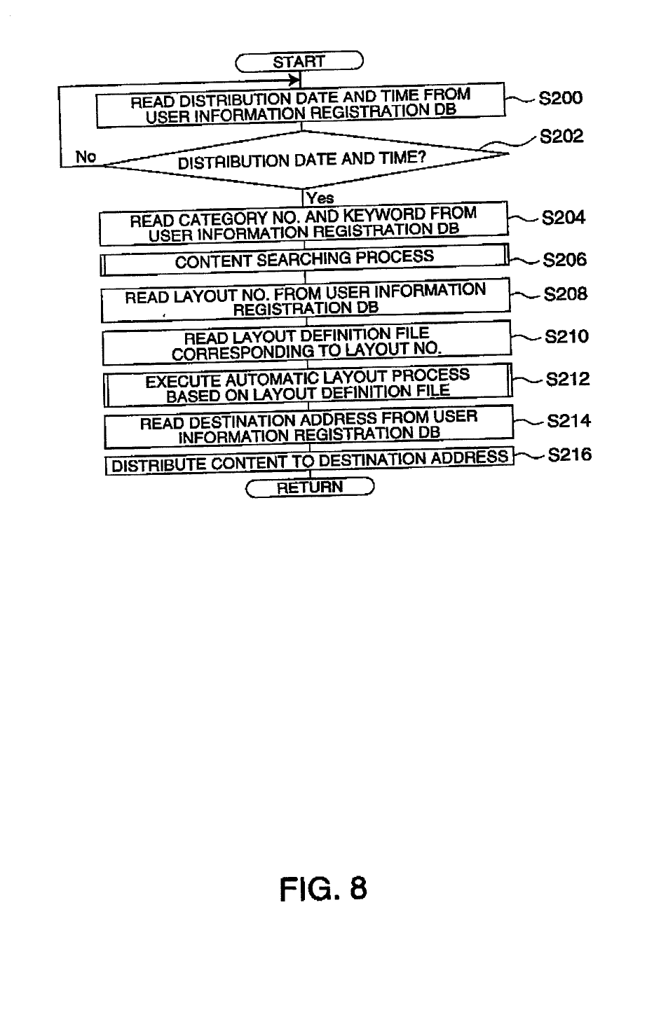

Next, the content distribution process will be described in detail with reference to FIG. 8. FIG. 8 is a flowchart showing the content distribution process.

In the content distribution process, digital content is distributed to the user terminal 200 with reference to the user profile table 300. When the content distribution process is executed by the CPU 30, the process first enters step S200, as shown in FIG. 8. Processing in each subsequent step deals with a single record in the user profile table 300. Actually, however, the processing in each step is repeated for the number of records registered in the user profile table 300.

In step S200, the distribution date and the distribution time are read from the user profile table 300. The process proceeds to step S202, in which it is determined whether a date and time has come when digital content be distributed based on the distribution date and the distribution time which have been read. If it is determined that a date and time has come when digital content be distributed (Yes), the process proceeds to step S204, whereas otherwise (No), the process proceeds to step S200.

In step S204, the category No. and the keyword are read from the user profile table 300. The process proceeds to step S206, in which a content searching process is performed to search the content registration DB 42 for content for postings based on the category No. and the keyword which have been read. The process then proceeds to step S208.

In step S208, the layout No. is read from the user profile table 300. The process then proceeds to step S210, in which the layout definition file corresponding to the layout No. which has been read is read from the user information registration DB 40 with reference to the layout No. association table 330. The process then proceeds to step S212, in which an automatic layout process for laying out the content for postings retrieved in step S206 according to an output layout determined based on the layout definition file which has been read is executed, and the process proceeds to step S214.

In step S214, the destination address is read from the user profile table 300. The process then proceeds to step S216, in which the digital content which has been created is distributed to the destination address which has been read. The series of steps is then exited, returning to the originating process.

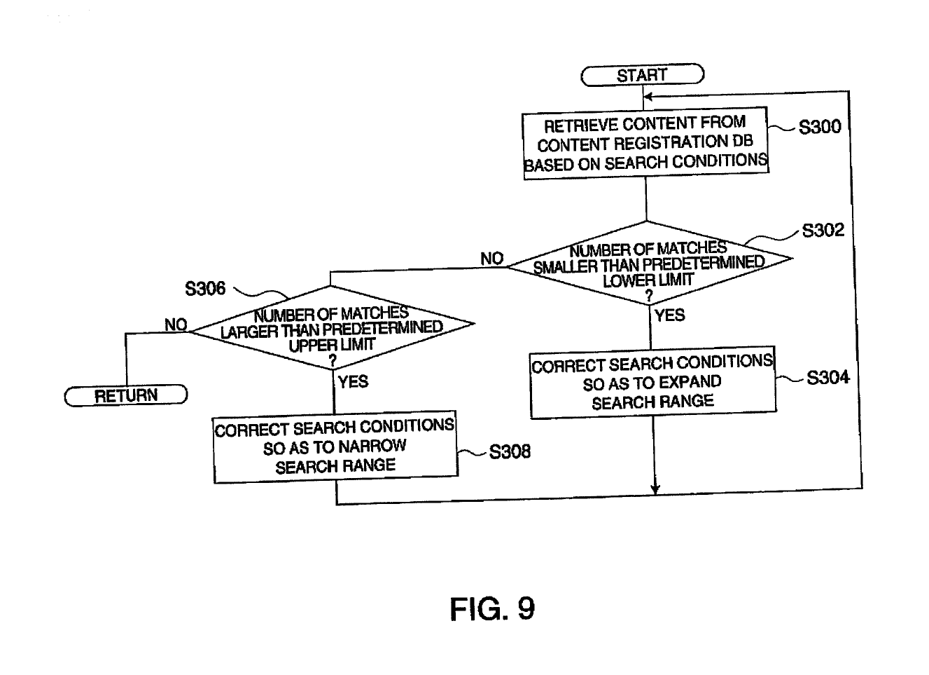

Next, the content searching process in step S206 will be described in detail with reference to FIG. 9. FIG. 9 is a flowchart showing the content searching process.

When the content searching process is executed in step S206, the process first enters step S300.

In step S300, the category No. and the keyword which have been read are assigned as search conditions, the content registration DB 42 is searched based on the search conditions, and content for postings with a category No. matching the assigned category No. and content for postings including the assigned keyword are retrieved, and the process then proceeds to step S302. More specifically, in step S300, a search for content for postings is performed according to the so-called Boolean logic, in which a search is performed according to a search expression using a plurality of search keys and a predetermined conditional expression or a single search key. For example, if a plurality of categories has been specified by the user, a search expression in which category Nos. respectively corresponding to the categories are joined by OR operators is formed, and a search is performed based on the search expression. Accordingly, content for postings which belongs to any of the categories specified by the user is retrieved. The same applies to a keyword search.

In step S302, it is determined whether the number of matches retrieved by the search is smaller than a predetermined lower limit. If it is determined that the number of matches is smaller than the predetermined lower limit (Yes), the process proceeds to step S304. The predetermined lower limit is set based on a predetermined number (e.g., the number of content for postings specified by the user) or a number which can be posted on a predetermined page (e.g., the number of pages of digital content specified by the user). For example, if the predetermined number or the number of which can be posted on the predetermined page is 10, the predetermined lower limit is set to be 10.

In step S304, the search conditions are corrected so as to expand the search range, and the process then proceeds to step S300. More specifically, in step S304, for example, if “domestic news” is specified by the user as a category of his interest or preference, if the number of matches is smaller than the predetermined lower limit, the main category of “news”, which is an upper level of “domestic news”, is added to the search conditions, thereby expanding the search range. That is, the category No. associated with the main category of “news” is joined to the search expression representing the current search conditions using an OR operator, creating a new search expression. By searching again using the search conditions, in addition to the number of matches retrieved already, content for postings which belongs to the main category of “news” is added in the number of matches.

The same applies to correction of keywords. In order to expand the search range in relation to keywords, for example, keywords associated to the assigned keyword is added with reference to a keyword association table in which keywords relevant in meaning are associated with each other, expanding the search range. More specifically, associated keywords are added to a search expression in the current search conditions using logic OR operator, forming a new search expression. By performing a search again based on the search conditions, in addition to the number of matches retrieved already, content for postings including the newly added keywords are added in the number of matches.

If it is determined in step S302 that the number of matches retrieved by the search is not smaller than the predetermined lower limit (No), the process proceeds to step S306, in which it is determined whether the number of matches is larger than a predetermined upper limit. If it is determined that the number of matches is larger than the predetermined upper limit (Yes), the process proceeds to step S308. The predetermined upper limit is set based on a predetermined number of items or a number of items which can be posted on a predetermined page. For example, if the predetermined number of news items or the number of news items which can be posted on the predetermined page is 10, the predetermined upper limit is set to be on the order of 20.

In step S308, the search conditions are corrected so as to narrow the search range, and the process proceeds to step S300. More specifically, in step S308, for example, in the case where the user has specified “domestic news” as a category which matches his interest or preference, if the number of matches is larger than the predetermined upper limit, for example, the second subcategory of “politics” which is at a lower level of “domestic news” is added to the search conditions in place of the first subcategory of “domestic news”, narrowing the search range. More specifically, the category No. corresponding to the first subcategory of “domestic news” is deleted from a search expression in the current search conditions, and to the search expression after the deletion, the category No. corresponding to the second subcategory of “politics” is joined using logic OR operator, forming a new search expression. By performing a search again based on the search conditions, among the number of matches retrieved already, content for postings which belongs to the second subcategories of “election” and “Cabinet and Diet” are excluded from the number of matches.

The same applies to correction of keywords. The search range may be narrowed in relation to keywords by replacing a keyword with a keyword having a subordinate concept, and if the user has specified a plurality of keywords, the keywords may be simply deleted.

In step S306, if it is determined that the number of matches retrieved by the search is not larger than the predetermined upper limit (No), the series of steps is exited, returning to the originating process.

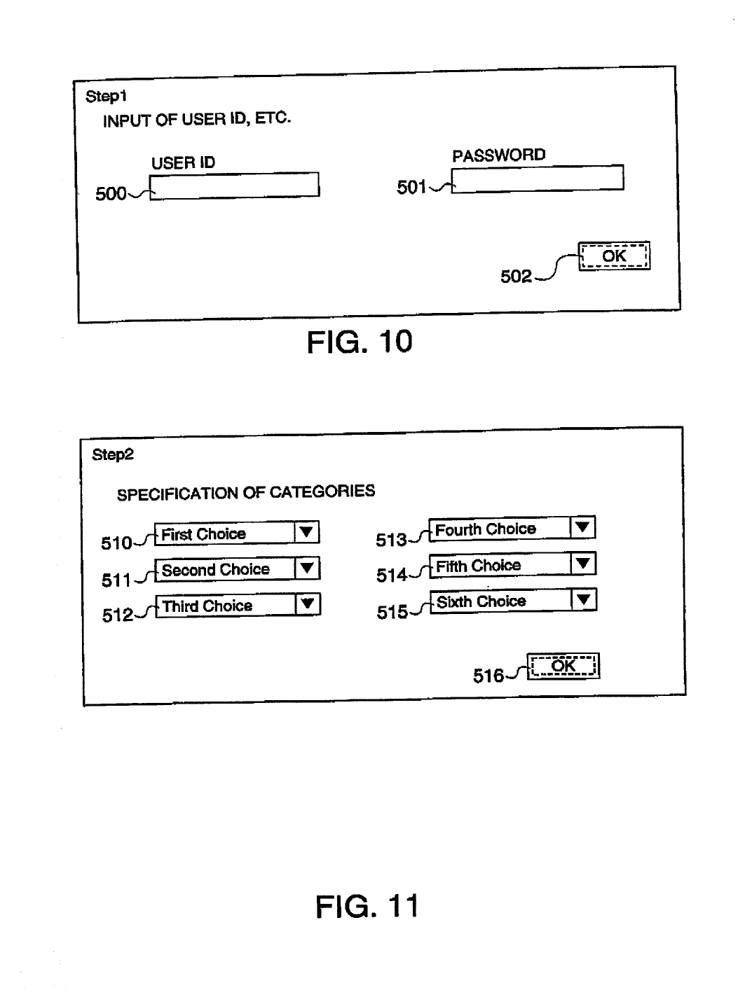

Next, the operation of the first embodiment will be described with reference to FIGS. 10 to 14.

First, registration of information required for distribution of digital content will be described.

When the user desires distribution of digital content, the user accesses the content distribution terminal 100 using a WWW browser on the user terminal 200, and inputs a user registration request.

When the user registration request is input, the user terminal 200 receives screen configuration data for configuring a user ID, etc. input screen for inputting a user ID, etc. by communicating with the content distribution terminal 100, and displays a screen as shown in FIG. 10 based on the screen configuration data. FIG. 10 is an illustration showing the user ID, etc. input screen.

As shown in FIG. 10, the user inputs a user ID and a password. The user ID and the password are input, for example, by inputting values, character strings, etc. respectively in text boxes 500 and 501 using a keyboard, etc. When the input of the user ID, etc. is complete, the user clicks on an “OK” button 502.

When the input of user ID, etc. is complete, the user terminal 200 transmits the user ID, etc. to the content distribution terminal 100. Then, the user terminal receives screen configuration data for configuring a category specification screen for specifying categories of digital content by communicating with the content distribution terminal 100, and displays a screen as shown in FIG. 11 based on the screen configuration data. FIG. 11 is an illustration showing the category specification screen.

As shown in FIG. 11, the user is allowed to specify up to six categories of digital content for which the user desires distribution. The categories of digital content are specified, for example, by selecting desired categories in combo boxes 510 to 515 in which a list of the categories is registered. When the input of categories is complete, the user clicks on an “OK” button 516.

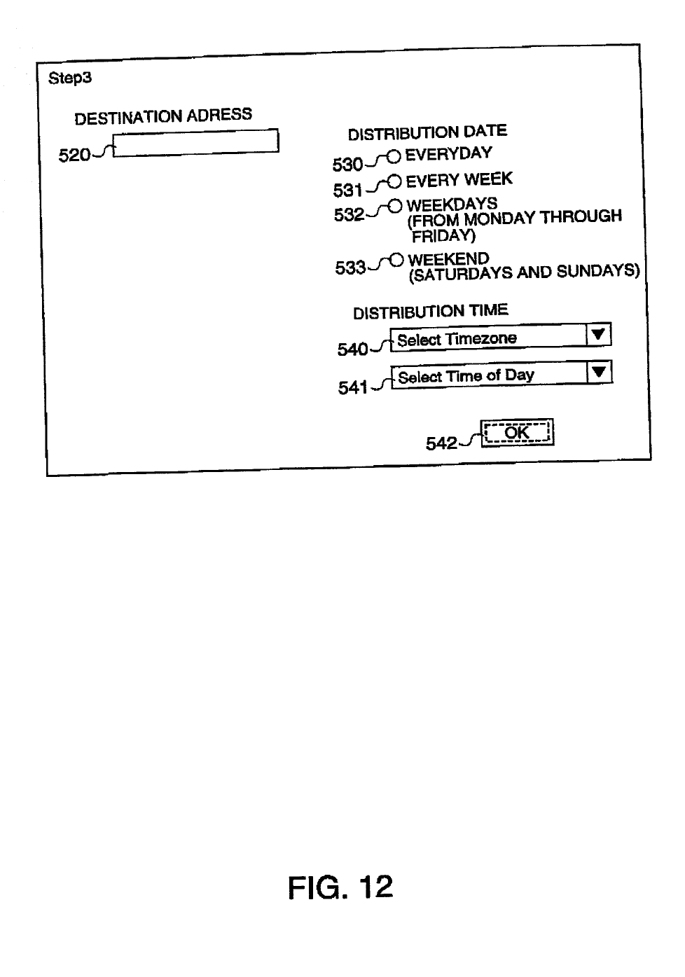

When the specification of categories is complete, the user terminal 200 transmits the specification of categories to the content distribution terminal 100. Then, the user terminal 200 receives screen configuration data for configuring a destination address, etc. input screen for inputting a destination address, etc. of digital content, and displays a screen as shown in FIG. 12 based on the screen configuration data. FIG. 12 is an illustration showing the destination address, etc. input screen.

Furthermore, as shown in FIG. 12, the user also inputs a destination address to which the user desires distribution, and a distribution date and a distribution time on which the user desires distribution. The destination address is input by inputting values, character strings, etc. in text box 520 using a keyboard, etc. The distribution date is input, for example, by selecting one of option buttons 530 to 533 for “every day”, “every week”, “weekdays (from Monday through Friday)”, and “weekend (Saturday and Sunday)”. The distribution time is input, for example, by selecting a desired distribution time in combo boxes 540 and 541 in which a list of distribution times is registered. When the inputs are complete, the user clicks on an “OK” button 542.

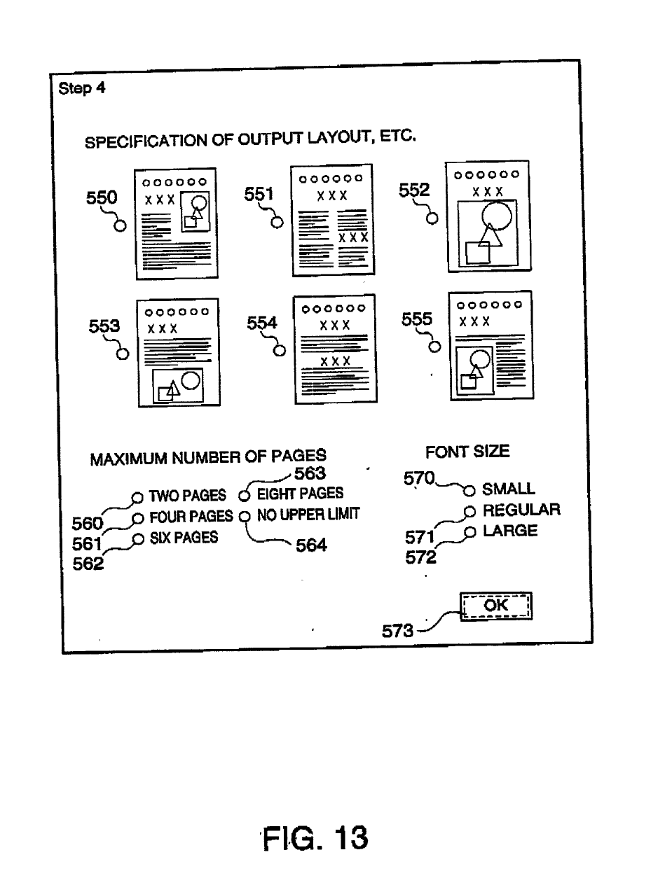

When the input of destination address, etc. is complete, the user terminal 200 transmits the destination address, etc. to the content distribution terminal 100. Then, the user terminal 200 receives screen configuration data for configuring an output layout, etc. specification screen for specifying output layout, etc. of digital content by communicating with the content distribution terminal 100, and displays a screen as shown in FIG. 13 based on the screen configuration data. FIG. 13 is an illustration showing the output layout, etc. specification screen.

As shown in FIG. 13, the user specifies a layout No., a maximum number of pages, and a font size. The layout No. is specified, for example, by selecting one of the six option buttons 550 to 555 respectively corresponding to sample images laid out according to each of the output layouts. The maximum number of pages is specified, for example, by selecting one of the option buttons 560 to 564 for “two pages”, “four pages”, “six pages”, “eight pages”, and “no upper limit”. The font size is specified, for example, by selecting one of the option buttons 570 to 572 for “small”, “regular”, and “large”. When the specification is complete, the user clicks on an “OK” button 573.

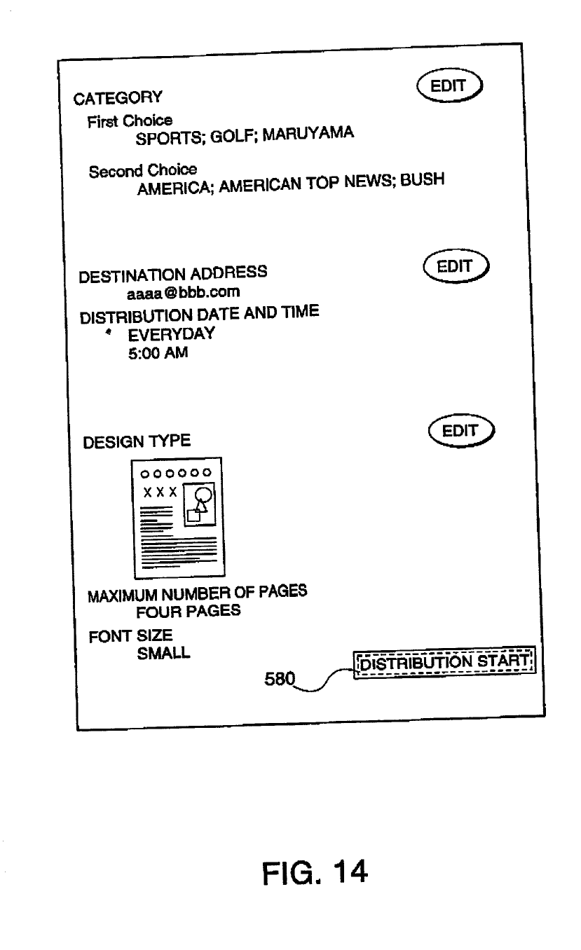

When the specification of output layout, etc. is complete, the user terminal 200 transmits the specification of output layout, etc. to the content distribution terminal 100. Then, the user terminal 200 receives screen configuration data for configuring a registration content confirmation screen for confirming the content of registration by communicating with the content distribution terminal 100, and displays a screen as shown in FIG. 14 based on the screen configuration data. FIG. 14 is an illustration showing the registration content confirmation screen.

In the example shown in FIG. 14, “sports; golf; Maruyama”, and “America; American top news; Bush” are displayed as the specification of categories, “aaa@bbb.com” as the destination address, and “every day” and “5:00 AM” as the distribution date and time. Furthermore, a sample image laid out according to an output layout is displayed as the output layout, “4 pages” as the maximum number of pages, and “small” as the font size. If the content of registration is correct, the user clicks on a “distribution start” button 580.

When the confirmation of registration content is complete, the user terminal 200 transmits a distribution start request to the content distribution terminal 100.

Upon receiving the distribution start request, in step S114, the content distribution terminal 100 registers in the user profile table 300 the specification of categories, and the specification of user ID, etc., and output layout, etc. which have been received.

Next, distribution of digital content with reference to the user profile table 300 will be described.

When a date and time for distribution of digital content with reference to the user profile table 300 has come, in steps S204 and S206, the content distribution terminal 100 reads the category No. and the keyword from the user profile table 300, and searches the content registration DB 42 for content for postings based on the category No. and the keyword which have been read. In the search, in step S300, the category No. and the keyword which have been read are assigned as search conditions, and the content registration DB 42 is searched based on the search conditions, whereby content for postings with a category No. matching the assigned category No. and content for postings including the keyword are retrieved.

If the number of matches retrieved as the result of the search is smaller than the predetermined lower limit, in step S304, the search conditions are corrected so as to expand the search range. In the correction, regarding the search condition for category No., an upper-level category is added to the current category, and regarding the search condition for keyword, associated keywords are newly added to the current search condition. When the search conditions have been corrected, a search is performed again in step S300 based on the corrected search conditions. The correction and re-searching in step S304 are repeated until the number of matches reaches the predetermined lower limit or above.

If the number of matches retrieved by the search is larger than the predetermined upper limit, in step S308, the search conditions are corrected so as to narrow the search range. In the correction, regarding the search condition for category No., the current category is replaced by one of its lower-level categories, and regarding the search conditions for keyword, one of the keywords included in the search condition is deleted. When the search conditions have been corrected, a search is performed again in step S300 based on the corrected search conditions. The correction and re-searching in step S308 are repeated until the number of matches falls to the predetermined upper limit or below.

If the number of matches in the result of the search is not smaller than the predetermined lower limit and not larger than the predetermined upper limit, it is likely that a search result desirable for the user and a required number of matches have been obtained; thus, correction of search conditions and re-searching are not performed.

Then, in steps S208 to S212, the layout No. is read from the user profile table 300, the layout definition file corresponding to the layout No. which has been read is read from the user information registration DB 40 with reference to the layout No. association table 330, and the content for postings which has been retrieved is laid out according to the output layout determined therefor.

Then, in steps S214 and S216, the destination address is read from the user profile table 300, and the digital content which has been created is distributed to the destination address which has been read.

As described above, according to this embodiment, the content distribution terminal 100 searches the content registration DB 42 for content for postings based on assigned search conditions, corrects the search conditions by adding categories and keywords if the number of matches retrieved by the search is smaller than a predetermined lower limit, and performs a search again based on the corrected search conditions.

Accordingly, a required number of matches can be expected, reducing the possibility of the format of digital content being deteriorated compared with before.

Furthermore, according to this embodiment, the content distribution terminal 100 searches the content registration DB 42 for content for postings based on assigned search conditions, corrects the search conditions by replacing the category by a lower-level category or deleting a keyword if the number of matches retrieved by the search is larger than a predetermined upper limit, and performs a search again based on the corrected search conditions.

Accordingly, a search result desirable for the user can be expected, providing digital content relatively matching interest or preference of the user compared with before.

Furthermore, according to this embodiment, the content distribution terminal 100 includes the user information registration DB 40 storing a plurality of layout definition files, and when user information including a destination address and a selection of output layout are input, the content distribution terminal 100 registers the input user information in the user information registration DB 40 in association with the selected layout definition file, lays out content for postings according to an output layout determined based on the layout definition file in the user registration DB 40, and distributes digital content which has been created based on the destination address associated with the layout definition file used for the layout.

Accordingly, the digital content can be output in an output layout relatively desirable for the user, and thus the digital content can be output in an output layout more viewable for the user compared with before.

Furthermore, according to this embodiment, the content distribution terminal 100 includes the content registration DB 42 storing a plurality of content for postings, and the content distribution terminal 100 reads a category No. and a layout definition file associated therewith from the user information registration DB 40, selects content for postings from the content registration DB 42 based on the category No. which has been read, and lays out the selected content for postings according to an output layout determined based on the layout definition file which has been read.

Accordingly, only digital content for postings relatively desirable for the user is laid out, alleviating the problem in viewing associated with unwanted content for postings being laid out together; thus the digital content can be output in an output layout even more viewable for the user.

Furthermore, according to this embodiment, the content distribution terminal 100 distributes digital content which has been created based on a distribution date and a distribution time associated with a layout definition file used in creating the digital content.

Accordingly, the digital content is distributed at a time relatively desirable for the user; thus, a distribution service more satisfactory for the user can be provided compared with before.

In the first embodiment described above, the content registration DB 42 corresponds to storage means in Claim 1 or 15, or content storage means in Claim 4 or 14. The user information registration DB 40 corresponds to user information storage means in Claim 14. Step S300 corresponds to content searching means in Claim 4 or 8, or content selecting means in Claim 14. Steps S304 and S308 correspond to search condition correcting means in Claim 4, 7, 8, 9, or 13. Step S212 corresponds to content creating means in Claim 14. Step S216 corresponds to content distribution means in Claim 14.

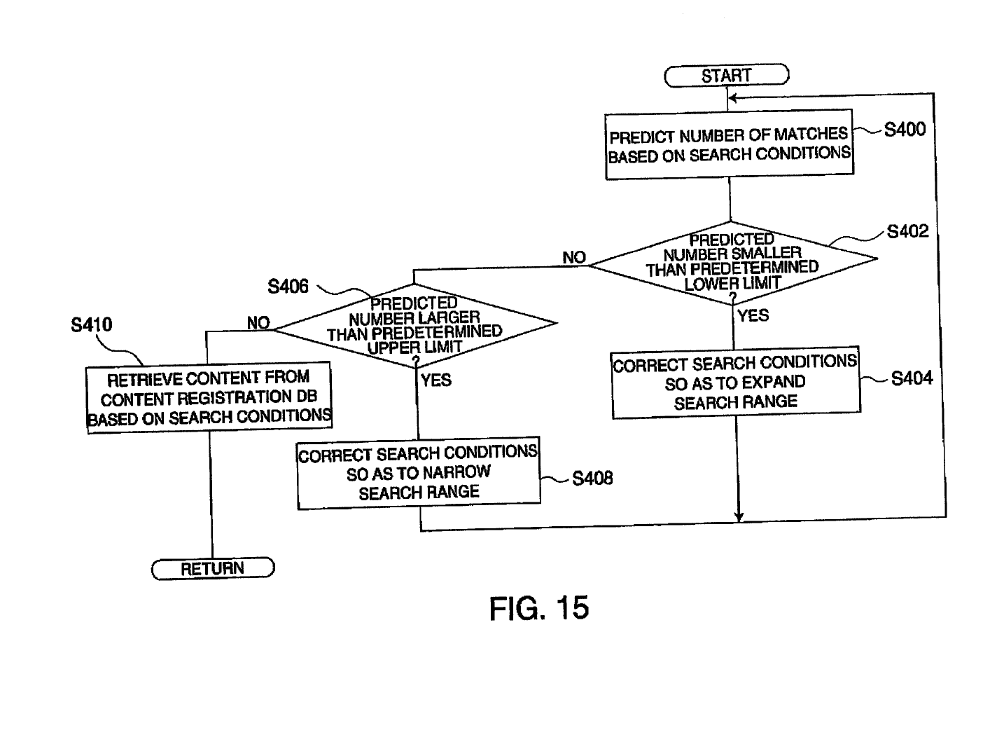

Next, a second embodiment of the present invention will be described with reference to the drawings. FIG. 15 is a diagram showing the second embodiment of an information searching system, a content search system, a content distribution system, and a storage medium according to the present invention. Hereinafter, description will be made only for parts which differ from the first embodiment already described, and identical parts will be designated by the same characters and description thereof will be omitted.

This embodiment applies an information searching system, a content search system, a content distribution system, and a storage medium to a case where the content distribution terminal 100 distributes digital content such as news to the user terminal 200 as shown in FIG. 1, and differs from the first embodiment in that a presumable number of matches to be retrieved by a search is predicted and search conditions are corrected in accordance with the result of the prediction.

First, the content searching process in step S206 will be described in detail with reference to FIG. 15. FIG. 15 is a flowchart showing the content searching process.

The content searching process, when executed in step S206, first enters step S400, as shown in FIG. 15.

In step S400, a presumable number of matches to be retrieved by a search is predicted based on search conditions, and the process proceeds to step S402. The number of matches can be obtained by statistical methods based on the kind and the number of categories specified by the user and the kind and the number of keywords specified by the user. The prediction of the number of matches is based on the conventional example.

In step S402, it is determined whether the predicted number is smaller than a predetermined lower limit. If it is determined that the predicted number is smaller than the predetermined lower limit (Yes), the process proceeds to step S404, in which the search conditions are corrected so as to expand the search range in the same manner as in step S304 in the first embodiment, and the process proceeds to step S400.

If it is determined in step S402 that the predicted number is not smaller than the predetermined lower limit (No), the process proceeds to step S406, in which it is determined whether the predicted number is larger than a predetermined upper limit. If it is determined that the predicted number is larger than the predetermined upper limit (Yes), the process proceeds to step S408, in which the search conditions are corrected so as to narrow the search range in the same manner as in step S308 in the first embodiment, and the process proceeds to step S400.

If it is determined in step S406 that the predicted number is not larger than the predetermined upper limit (No), the process proceeds to step S410, in which, in the same manner as in step S300 in the first embodiment, a category No. and a keyword are assigned as search conditions, the content registration DB 42 is searched based on the search conditions, retrieving content for postings with a category No. matching the assigned category No. and content for postings including the assigned keyword. The series of steps is then exited, returning to the originating process.

Next, the operation of the second embodiment will be described.

When a date and time come when digital content is to be distributed with reference to the user profile table 300, in steps S204, S206, and S400, the content distribution terminal 100 reads a category No. and a keyword from the user profile table 300, and predicts a presumable number of matches to be retrieved by a search based on the category No. and the keyword which have been read.

If the predicted number in the result is smaller than a predetermined lower limit, in step S404, the search conditions are corrected so as to expand the search range. In the correction, regarding the search condition for category No., an upper-level category is added to the current category, and regarding the search condition for keyword, associated keywords are newly added to the current search condition. When the search conditions have been corrected, a prediction is performed again in step S400 based on the corrected search conditions. The correction and re-prediction in step S404 are repeated until the predicted number reaches the predetermined lower limit or above.

If the predicted number is larger than the predetermined upper limit, in step S408, the search conditions are corrected so as to narrow the search range. In the correction, regarding the search condition for category No., the current category is replaced by one of its lower-level categories, and regarding the search conditions for keyword, one of the keywords included in the search condition is deleted. When the search conditions have been corrected, a prediction is performed again in step S400 based on the corrected search conditions. The correction and re-prediction in step S408 are repeated until the number of matches falls to the predetermined upper limit or below.

If the predicted number in the result of the prediction is not smaller than the predetermined lower limit and not larger than the predetermined upper limit, it is likely that a search result desirable for the user and a required number of matches will be obtained; thus, correction of search conditions and re-prediction are not performed.

Then, in steps S410 and S208 to S212, the content registration DB 42 is searched for content for postings based on the category No. and the keyword, the layout No. is read from the user profile table 300, the layout definition file corresponding to the layout No. which has been read is read from the user information registration DB 40 with reference to the layout No. association table 330, and the content for postings which has been retrieved is laid out according to the output layout determined based on the layout definition file which has been read.

Then, in steps S214 and S216, the destination address is read from the user profile table 300, and the digital content which has been created is distributed to the destination address which has been read.

As described above, according to this embodiment, the content distribution terminal 100 predicts a presumable number of matches to be retrieved by a search based on assigned search conditions, corrects the search conditions by adding categories and keywords if the predicted number is smaller than a predetermined lower limit while correcting the search conditions by replacing the category with a lower-level category or deleting keywords if the predicted number is larger than a predetermined upper limit, performs a prediction again based on the corrected search conditions, and search the content registration DB 42 for content for postings when the predicted number has satisfied the conditions.

Accordingly, in addition to the advantages of the first embodiment, because a search is performed after the correction of search conditions is complete, the number of searches required to obtain a required number of matches can be reduced. Thus, processing time and processing load can be reduced.

In the second embodiment described above, the content registration DB 42 corresponds to storage means in Claim 2 or 16, or content storage means in Claim 5 or 14. The user information registration DB 40 corresponds to user information storage means in Claim 14. Step S400 corresponds to prediction means in Claim 5. Step S410 corresponds to content searching means in Claim 5 or 11, or content selecting means in Claim 14. Steps S404 and S408 correspond to search condition correcting means in Claim 5, 10, 11, 12, or 13. Step S212 corresponds to content creating means in Claim 14. Step S216 corresponds to content distribution means in Claim 14.

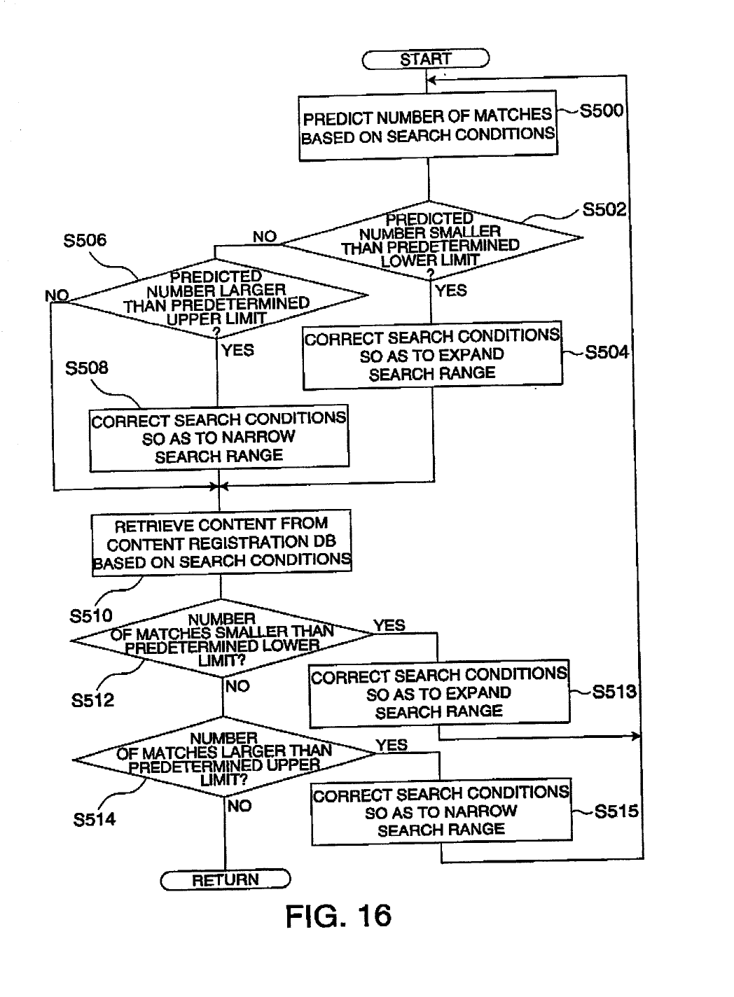

Next, a third embodiment of the present invention will be described with reference to the drawings. FIG. 16 is a diagram showing the third embodiment of an information searching system, a content search system, a content distribution system, and a storage medium according to the present invention. Hereinafter, description will be made only for parts which differ from the first embodiment already described, and identical parts will be designated by the same characters and description thereof will be omitted.

This embodiment applies an information searching system, a content search system, a content distribution system, and a storage medium to a case where the content distribution terminal 100 distributes digital content such as news to the user terminal 200 as shown in FIG. 1, and differs from the first embodiment in that the series of steps for predicting a presumable number of matches to be retrieved by a search and correcting search conditions based on the result of the prediction is repeated until an actual number of matches satisfies a predetermined condition.

First, the content searching process in step S206 will be described in detail with reference to FIG. 16. FIG. 16 is a flowchart showing the content searching process.

The content searching process, when executed in step S206, first enters step S500, as shown in FIG. 16.

In step S500, the number of matches is predicted in the same manner as in step S400 in the second embodiment. The process then proceeds to step S502, in which it is determined whether the predicted number is smaller than a predetermined lower limit. If it is determined that the predicted number is smaller than the predetermined lower limit (Yes), the process proceeds to step S504, in which the search conditions are corrected so as to expand the search range in the same manner as in step S304 in the first embodiment, and the process proceeds to step S510.

In step S510, a search is performed in the same manner as in step S410 in the second embodiment. The process then proceeds to step S512, in which it is determined whether the number of matches retrieved by the search is smaller than the predetermined lower limit. If it is determined that the number of matches is smaller than the predetermined lower limit (Yes), the process proceeds to step S513, in which the search conditions are corrected in the same manner as in step S304 in the first embodiment, and the process proceeds to step S500.

If it is determined in step S512 that the number of matches retrieved by the search is not smaller than the predetermined lower limit (No), the process proceeds to step S514, in which it is determined whether the number of matches retrieved by the search is larger than the predetermined upper limit. If it is determined that the number of matches is larger than the predetermined upper limit (Yes), the process proceeds to step S515, in which the search conditions are corrected in the same manner as in step S308 in the first embodiment, and the process proceeds to step S500.

If it is determined in step S502 that the predicted number is not smaller than the predetermined lower limit (No), the process proceeds to step S506, in which it is determined whether the predicted number is larger than the predetermined upper limit. If it is determined that the predicted number is larger than the predetermined upper limit (Yes), the process proceeds to step S508, in which the search conditions are corrected so as to narrow the search range in the same manner as in step S308 in the first embodiment, and the process proceeds to step S510.

If it is determined in step S506 that the predicted number is not larger than the predetermined upper limit (No), the process proceeds to step S510.

Next, the operation of the third embodiment will be described.

When a date and time come when digital content is to be distributed with reference to the user profile table 300, in steps S204, S206, and S500, the content distribution terminal 100 reads a category No. and a keyword from the user profile table 300, and predicts a presumable number of matches to be retrieved by a search based on the category No. and the keyword which have been read.

If the predicted number in the result is smaller than a predetermined lower limit, in step S504, the search conditions are corrected so as to expand the search range. In the correction, regarding the search condition for category No., an upper-level category is added to the current category, and regarding the search condition for keyword, associated keywords are newly added to the current search condition. When the search conditions have been corrected, in step S510, the content registration DB 42 is searched for content for postings based on the category No. and the keyword. If the actual number of matches is smaller than the predetermined lower limit or larger than the predetermined upper limit, a prediction is performed again in step S500 based on the corrected search conditions. The correction, searching, and re-prediction in step S504 are repeated until the predicted number becomes not smaller than the predetermined lower limit and not larger than the predetermined upper limit.

If the predicted number is larger than the predetermined upper limit, in step S508, the search conditions are corrected so as to narrow the search range. In the correction, regarding the search condition for category No., the current category is replaced by one of its lower-level categories, and regarding the search conditions for keyword, one of the keywords included in the search condition is deleted. When the search conditions have been corrected, in step S510, the content registration DB 42 is searched for content for postings based on the category No. and the keyword. If the actual number of matches in the result is smaller than the predetermined lower limit or larger than the predetermined upper limit, a prediction is performed again in step S500 based on the corrected search conditions. The correction, searching, and re-prediction in step S508 are repeated until the number of matches becomes not smaller than the predetermined lower limit and not larger than the predetermined upper limit.

If the predicted number in the result of the prediction is not smaller than the predetermined lower limit and not larger than the predetermined upper limit, it is likely that a search result desirable for the user and a required number of matches will be obtained; thus, re-prediction is not performed.

Then, in steps S208 to S212, the layout No. is read from the user profile table 300, the layout definition file corresponding to the layout No. which has been read is read from the user information registration DB 40 with reference to the layout No. association table 330, and the content for postings which has been retrieved is laid out according to the output layout determined based on the layout definition file which has been read.

Then, in steps S214 and S216, the destination address is read from the user profile table 300, and the digital content which has been created is distributed to the destination address which has been read.

As described above, according to this embodiment, the content distribution terminal 100 predicts a presumable number of matches to be retrieved by a search based on assigned search conditions, corrects the search conditions by adding categories and keywords if the predicted number is smaller than a predetermined lower limit while correcting the search conditions by replacing the category with a lower-level category or deleting keywords if the predicted number is larger than a predetermined upper limit, performs a search based on the corrected search conditions, and performs a search again if the actual number of matches is smaller than the predetermined lower limit or larger than the predetermined upper limit.

Accordingly, advantages equivalent to those in the first embodiment can be obtained.

In the third embodiment described above, the content registration DB 42 corresponds to storage means in Claim 3 or 16, or content storage means in Claim 6 or 14. The user information registration DB 40 corresponds to user information storage means in Claim 14. Step S500 corresponds to prediction means in Claim 6. Step S510 corresponds to content searching means in Claim 6 or 11, or content selecting means in Claim 14. Steps S504 and S508 correspond to search condition correcting means in Claim 6, 10, 11, 12, or 13. Step S212 corresponds to content creating means in Claim 14. Step S216 corresponds to content distribution means in Claim 14.

In the first to the third embodiments described above, when keywords are added, keywords associated with an assigned keyword are added, for example, with reference to a keyword association table in which keywords relevant in meaning are associated with each other. However, in the keyword association table, keywords extracted from content for postings in the content registration DB 42 may be registered, or keywords extracted from external terminals connected to the Internet 199, such as the content providing terminals S₁ to Sₙ, may be registered.

Furthermore, in the first to the third embodiments described above, the search range is expanded by adding categories and keywords. In addition, the search range may be expanded by deleting one of the keyword joined by logic AND. In that case, it is preferable that the importance of keywords is obtained from the content for postings in the content registration DB 42 and priority is given to keywords with lower importance when deleting the keywords. Furthermore, the search range may be expanded by replacing logic AND operator included in a search expression with logic OR operator, and conversely, the search range may be narrowed by replacing logic OR operator included in a search expression with logic AND operator.

Furthermore, in the first to the third embodiments described above, categories are classified hierarchically. However, without limitation thereto, the categories may be classified in the form of a bidirectional list or a unidirectional list. For example, subsequent to the category of “sports”, the category of “golf” is linked. This differs from the hierarchical classification in that, for example, the category of “golf” may be classified under the category of “sports”, and also, for example, under the category of “health” which is at the same level as the category of “sports”.

Furthermore, in the first to the third embodiments described above, the description is such that a control program stored in advance in the ROM 32 is executed when executing each of the processes shown in FIGS. 7 to 9 and FIGS. 15 and 16. However, without limitation thereto, a program showing the procedures may be read from a storage medium storing the program into the RAM 34 to be executed. Alternatively, the program may be downloaded from a network to be executed.

The storage medium is a semiconductor storage medium such as a RAM or a ROM, a magnetic-storage storage medium such as an FD or an HD, an optical-storage medium such as a CD, a CDV, an LD, or a DVD, or a magnetic-storage/optical-reading storage medium such as an MO, and includes any computer-readable storage medium regardless of reading methods such as electronic, magnetic, or optical.

Furthermore, in the first to the third embodiments described above, a case where an information searching system, a content search system, a content distribution system, and a storage medium according to the present invention are applied to a network system including the Internet 199 is described. However, without limitation thereto, for example, the present invention may be applied to a so-called intranet in which communications are based on the same method as in the Internet 199. Obviously, the present invention may be applied to ordinary networks without limitation to networks in which communications are based on the same method as in the Internet 199.

Furthermore, in the first to the third embodiment described above, an information searching system, a content search system, a content distribution system, and a storage medium according to the present invention are applied to a case where the content distribution terminal 100 distributes digital content such as news to the user terminal 200, as shown in FIG. 1. However, without limitation thereto, they may also be applied to other cases without departing from the gist of the present invention.

As described above, an information searching system according to the present invention provides the advantage that a search result desirable for the user or a required number of matches can be expected.

Furthermore, an information searching system according to the present invention also provides the advantage that processing time and processing load can be reduced because the number of searches required for obtaining a required number of matches can be reduced.

A content search system according to the present invention provides the advantage that a search result desirable for the user or a required number of matches can be expected.

Furthermore, a content search system according to the present invention also provides the advantage that processing time and processing load can be reduced because the number of searches required for obtaining a required number of matches can be reduced.

Furthermore, a content search system according to the present invention also provides the advantage that ordering according to general criteria or popular interest is possible by adding search keys associated with a search key included in a search expression of search conditions.

A content distribution system according to the present invention provides advantages equivalent to those of the above content search system.

A storage medium storing an information searching program according to the present invention provides advantages equivalent to those of the above information searching system.

1) A system for searching for information from the storage means,
the information searching system characterized by performing a search based on assigned search conditions, correcting the search conditions if the number of matches or the amount of data retrieved by the search does not satisfy a predetermined condition, and performing a search again based on the corrected search conditions.

2) A system for searching for information from the storage means,
the information searching system characterized by predicting a presumable number of matches or amount of data to be retrieved by a search based on assigned search conditions, correcting the search conditions if the result of the prediction does not satisfy a predetermined condition, performing a prediction again based on the corrected search conditions, and performing a search based on the search conditions if the result of the prediction satisfies the predetermined condition.

3) A system for searching for information from the storage means,
the information searching system characterized by predicting a presumable number of matches or amount of data to be retrieved by a search based on assigned search conditions, correcting the search conditions if the result of the prediction does not satisfy a first predetermined condition, performing a search based on the corrected search conditions, correcting the search conditions if the number of matches retrieved by the search does not satisfy a second predetermined condition, and performing a prediction and a search again.

4) A system for searching a content storage means for content for postings, stored therein, of a predetermined number of items or a number of items which can be posted in a predetermined posting area when creating digital content on which the content for postings is posted,
the content search system characterized by comprising a content searching means for searching said content storage means for the content for postings based on assigned search conditions, and a search condition correcting means for correcting the search conditions if the number of matches retrieved by said content searching means does not satisfy a predetermined condition,
wherein said content searching means performs a search again based on the search conditions which have been corrected by said search condition correcting means.

5) A system for searching a content storage means for content for postings, stored therein, of a predetermined number of items or a number of items which can be posted in a predetermined posting area when creating digital content on which the content for postings is posted,
the content search system characterized by comprising a prediction means for predicting a presumable number of matches to be retrieved by a search based on assigned search conditions, a search condition correcting means for correcting the search conditions if the result of the prediction by said prediction means does not satisfy a predetermined condition, and a content searching means for searching said content storage means for the content for postings based on the search conditions satisfying the predetermined condition,
wherein said prediction means performs a prediction again based on the search conditions which have been corrected by said search condition correcting.

6) A system for searching a content storage means for content for postings, stored therein, of a predetermined number of items or a number of items which can be posted in a predetermined posting area when creating digital content on which the content for postings is posted,
the content search system characterized by comprising a predicting means for predicting a presumable number of matches to be retrieved by a search based on assigned search conditions, a search condition correcting means for correcting the search conditions, and a content searching means for searching said content storage means for the content for postings based on the search conditions,
wherein if the result of the prediction by said prediction means does not satisfy a first predetermined condition, said search condition correcting means performs a correction, and if the number of matches retrieved by said content searching means does not satisfy a second predetermined condition, said search condition correcting means performs a correction, said prediction means performs a prediction again, and said content searching means performs a search again.

7) A content search system according to one of claims 4 to 6,
characterized in that the search conditions include a category of the content for postings,
and said search condition correcting means narrows the range of the category in the search conditions if the number of matches is larger than a predetermined upper limit and expands the range of the category in the search conditions if the number of matches is smaller than a predetermined lower limit.

8) A content search system according to one of claims 4 to 7,
characterized in that the search conditions include a search expression consisting of a combination of a plurality of search keys and a predetermined conditional expression or a single search key,
said content searching means performs a search according to the search expression,
and said search condition correcting means alters the search expression in the search conditions so as to narrow the search range by said content searching means if the number of matches is larger than a predetermined upper limit and alters the search expression in the search conditions so as to expand the search range by said content searching means if the number of matches is smaller than a predetermined lower limit.

9) A content search system according to claim 8,
characterized in that said search condition correcting means increases the number of search keys included in the search expression in the search conditions if the number of matches is larger than the predetermined upper limit and decreases the number of search keys included in the search expression in the search conditions if the number of matches is smaller than the predetermined lower limit.

10) A content search system according to one of claims 5 and 6,
characterized in that the search conditions include a category of the content for postings,
and said search condition correcting means narrows the range of the category in the search conditions if the number of matches is determined to be presumably larger than a predetermined upper limit based on the result of the prediction and expands the range of the category in the search conditions if the number of matches is determined to be presumably smaller than a predetermined lower limit based on the result of the prediction.

11) A content search system according to one of claims 5, 6, and 10,
characterized in that the search conditions include a search expression consisting of a combination of a plurality of search keys and a predetermined conditional expression or a single search key,
said content searching means performs a search according to the search expression,
and said search condition correcting means alters the search expression in the search conditions so as to narrow the search range by said content searching means if the number of matches is determined to be presumably larger than a predetermined upper limit based on the result of the prediction and alters the search expression in the search conditions so as to expand the search range by said content searching means if the number of matches is determined to be presumably smaller than a predetermined lower limit based on the result of the prediction.

12) A content search system according to claim 11,
characterized in that said search condition correcting means increases the number of search keys included in the search expression in the search conditions if the number of matches is determined to be presumably larger than the predetermined upper limit based on the result of the prediction and decreases the number of search keys included in the search expression in the search conditions if the number of matches is determined to be presumably smaller than the predetermined lower limit based on the result of the prediction.

13) A content search system according to one of claims 9 and 12,
characterized in that said search condition correcting means adds a search key related to a search key included in the search expression in the search conditions when increasing the number of search keys.

14) A system for distributing digital content on which content for postings of a predetermined number of items or a number of items which can be posted in a predetermined posting area is posted to a user,
the content distribution system characterized by comprising a user information storage means for storing user information including search conditions specified by the user, a content storage means for storing the content for postings, a content selecting means for selecting the content for postings from said content storage means based on the search conditions in said user information storage means, a digital content creating means for creating the digital content using the content for postings selected by said content selecting means, and a content distribution means for distributing the digital content created by said content creating means to the user,
wherein a content search system according to one of claims 4 to 13 is applied to said content selecting means.

15) A computer-readable storage medium storing an information searching program for searching for information from the storage means,
the storage means characterized by storing a program for executing on a computer a process for performing a search based on assigned search conditions, correcting the search conditions if the number of matches retrieved by the search does not satisfy a predetermined condition, and performing a search again based on the corrected search conditions.

16) A computer-readable storage medium storing an information searching program for searching for information from the storage means,
the storage means characterized by storing a program for executing on a computer a process for predicting a presumable number of matches to be retrieved by a search based on assigned search conditions, correcting the search conditions if the result of the prediction does not satisfy a predetermined condition, performing a prediction again based on the corrected search conditions, and performing a search based on the search conditions if the result of the prediction satisfies the predetermined condition.

17) A computer-readable storage medium storing an information searching program for searching for information from the storage means,
the storage means characterized by storing a program for executing on a computer a process for predicting a presumable number of matches to be retrieved by a search based on assigned search conditions, correcting the search conditions if the result of the prediction does not satisfy a first predetermined condition, performing a search based on the corrected search conditions, correcting the search conditions if the number of matches retrieved by the search does not satisfy a second predetermined condition, and performing a prediction and a search again.
